(19) United States
(12) Patent Application Publication
(10) Pub. No.: US 2008/0244131 A1
(43) Pub. Date: Oct. 2, 2008

(54) ARCHITECTURE FOR CONFIGURABLE BUS ARBITRATION IN MULTIBUS SYSTEMS WITH CUSTOMIZABLE MASTER AND SLAVE CIRCUITS

(75) Inventors: Alain Vergnes, Trets (FR); Raphael Robert, Puyloubier (FR)

Correspondence Address: SCHWEGMAN, LUNDBERG & WOESSNER / ATMEL, P.O. BOX 2938, MINNEAPOLIS, MN, 55402, US

(73) Assignee: ATMEL CORPORATION, San Jose, CA (US)

(21) Appl. No.: 11/691,016

(22) Filed: Mar. 26, 2007

(51) Int. Cl. G06F 13/00

(52) U.S. Cl. 710/110

(57) ABSTRACT

An integrated multibus system includes a first and second master devices coupled to first and second master busses. A slave device is coupled to the first and second master busses through a first multiplexer, a first address decoder coupled to the first master bus having an output associated with the slave device, a second address decoder coupled to the second master bus and having an output associated with the slave device. A first arbiter circuit multiplexer has an output coupled to a select input of the first multiplexer. A first arbiter circuit is coupled to the outputs of the first and second address decoders, the first arbiter circuit having an output that is a predetermined function of the address decoder outputs and is coupled to an input of the first arbiter circuit multiplexer. A configurable logic area has a first net coupled to an input of the arbiter circuit multiplexer.

### BACKGROUND OF THE INVENTION

1. Field of the Invention

The present invention relates to micro-controller integrated circuits including a customizable logic area and a predefined logic area that are accessible via the microprocessor. More particularly, the present invention relates to architecture to implement configurable bus arbitration schemes in multibus systems having customizable master and slave circuits.

2. The Prior Art

Due to the wide variety of available software applications, it is difficult to design a standard microcontroller product that includes all possible modules to efficiently address these applications. The application specific integrated circuit (ASIC) market addresses that need by allowing a user to specify custom modules. The initial development cost of an ASIC remains expensive. A known work-around consists of adding a customizable area of logic to an already predefined microcontroller logic, the customizable area being formed as a field programmable gate array or other logic that can be customized by, for example, modifying the metal interconnect layers. This last solution is a trade-off between the size of the logic, which is smaller than FPGA area for an equivalent function, and a front-end cost including the design of the metal layer and one time customization cost.

In such a prior-art architecture, the predefined logic implements a microcontroller function that cannot be modified but contains access points that connect to the customizable logic area. These access points are generally the system bus of the microcontroller.

Referring now to FIG. 1, an illustrative prior-art architecture of this type is shown. A basic micro-controller architecture 10 including a customizable logic module includes the microprocessor 12 that executes a set of instructions that can be stored outside the integrated circuit in a memory device (not shown) which is controlled by the external bus interface (EBI) 14 that communicates with the external memory via EBI bus portions 16 and 18 as is known in the art. The set of instructions may also be located in a ROM or Embedded Flash acting as an on-chip memory 20. An address decoder module 22 selects one module from among all possible modules coupled to a system bus 34 over select lines 26, 28, 30, or 32 as is known in the art. The system bus 34 includes (not shown) an address bus, a write data bus, a read data bus and control signals such as read/write. Among the modules commonly encountered in such a system are an interrupt controller 36 and a UART 38 that sends and receives signals via I/O 40. A customizable area 42 may be included to allow a user to implement a custom function in the system. Customizable area 42 may send and receive signals via I/O 44. Clock terminal 46 supplies a clock signal to time all the modules and reset terminal 48 supplies a reset signal to initialize all the modules.

The microprocessor 12 executes instructions that can be stored outside the chip by driving the address bus 34 to a value corresponding to the EBI module 14. The address decoder 22 asserts the corresponding selection signal 26. To fetch the instruction, the direction control (read/write) signal of the system bus is asserted for read operation mode. The value can be either logical 1 or 0 depending on the system bus protocol. The EBI module 14 then drives the external memory device to obtain the data required by the microprocessor 12. EBI bus portion 16 is driven by the EBI module 14, and by the address and control signal set. The off-chip memory returns the instruction to be executed on EBI bus portion 18. The EBI module returns the instruction data value on internal system bus 34 and the microprocessor 12 is then ready to execute the instruction.

If the instruction is a write instruction to one of the modules coupled to the system bus 34, the microprocessor 12 performs another similar fetch to obtain the destination address of the peripheral device to which the data must be written. The microprocessor 12 then executes the write instruction to the selected peripheral by asserting on the system address bus a value selecting (for example) the UART module 38. The address decoder 22 deselects the EBI 14 by clearing the associated selection signal 32 and asserts the selection signal 28 corresponding to the UART module 38.

Being selected for a write operation, the UART module 38 writes into its internal registers the value on the write data bus portion of system bus 34. The other modules receive this value but do not take any action because they are not selected. The UART module 38 converts the parallel internal stored data to a bit stream that is clocked out on I/O 40.

The instructions are sequentially executed and perform read or write operations on the system bus. The microprocessor 12 can also be triggered by a peripheral using the interrupt line 50 driven by the interrupt controller 36, which handles the priorities of the interrupt lines 52 and 54 coming from peripheral modules 38 and 42. For example if the expected result from a peripheral is known to have a latency of several tens of clock cycles, it is better to trigger the interrupt line rather than wait for the result by executing some kind of no-operation instruction, especially when several peripherals, such as UARTs and crypto-processors, have a long latency response compared to the clock cycle period.

The customizable logic area 42 can be designed using an FPGA-based architecture. Therefore, this logic will be able to be programmed in the field. The architecture can also be gate-array based. In this case, for the same area, the cell density is much higher than in an FPGA, but the functionality can be defined only once. To obtain the desired function, the metal layers must be designed according to the cells (gates) available on the gate array. In the gate array, the placement of the gates is always the same whatever the functionality.

As a consequence, it is cheaper to design a new micro-controller with this method rather than by generating a full masks reticle for each new circuit. Only the last layers are redesigned and manufacture time is significantly reduced.

The customizable logic area 42 needs to be connected to predefined logic to be accessible by the microprocessor 12. Therefore, the system bus 34 communicates with customizable logic 42. For example, if the system bus 34 selects data using non-tristate cells (i.e. multiplexers using NAND or other gates), these multiplexers will have dedicated inputs that will be driven by circuitry in the customizable logic area 42.

The same idea applies for the address decoder 22. Several signals 30 from the address decoder 22 are already decoded and routed to the customizable logic area 42. This kind of routing is necessary to enable the microprocessor 12 to gain access to the customizable logic area 42.

### BRIEF DESCRIPTION OF THE INVENTION

The present invention defines specific access points to provide more flexibility, especially in the domain of system bus arbitration.

Circuitry may be used to make individual circuits different from one another. Such differentiation circuitry includes circuitry to implement the arbitration algorithm used by the system bus of the microcontroller architecture built in the predefined area. If only one built-in arbitration scheme is available, there is a probability that it will not be efficient for a particular customer application. Therefore, there is a need for adding flexibility to these prior-art schemes.

According to one aspect of the invention, a multi-bus system includes customizable master and slave modules and customizable bus arbitration that may be wholly or partly implemented in the customizable logic area.

In one embodiment of the present invention, a multibus system comprises a customizable logic area having a configured custom master module and a configured custom slave module. This multibus system includes additional user arbitration circuitry disposed in the customizable logic area that uses multiplexers already disposed in a predefined logic area.

In an alternative embodiment of the present invention, a multibus system comprises a customizable logic area having a configured custom master module and a configured custom slave module. This multibus system includes a multiplexer formed in the customizable logic area and the output of a predefined slave arbiter being routed to the mulitplexer in the customizable logic area.

In another alternative embodiment of the present invention, a multibus system comprises a customizable logic area having a configured custom master module and a configured custom slave module. In this multibus system, a configuration is provided where additional arbitration capabilities within the customizable logic area are not required since the user does not want to implement its own slave arbitration algorithm. Accordingly, the customizable logic area does not include a custom user arbitration algorithm. The associated I/O terminals of the customizable logic area are connected together rather than to a multiplexer in the customizable logic area.

### BRIEF DESCRIPTION OF THE DRAWING FIGURES

FIG. 1 is a block diagram of a generic micro-controller architecture with customizable logic module in which the present invention may be employed.

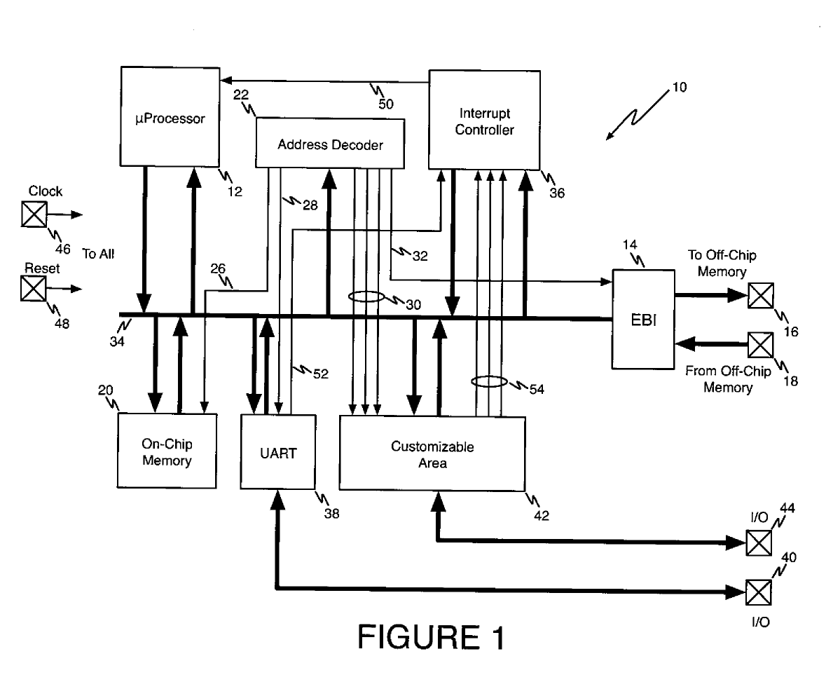

FIG. 2 is a block diagram of a prior-art multibus master-slave system.

FIG. 3 is a block diagram of a prior-art multibus master-slave system including a customizable logic area with a configured custom master module and a configured custom slave module.

FIG. 4 is a block diagram of an illustrative integrated multibus master-slave system according to the present invention including a customizable logic area with a configured custom master module and a configured custom slave module including additional arbitration capabilities with multiplexers in the predefined circuit area.

FIG. 5 is a block diagram of an illustrative integrated multibus master-slave system according to the present invention including a customizable logic area with a configured custom master module and a configured custom slave module including additional arbitration capabilities with multiplexers in the customizable logic area.

FIG. 6 is a block diagram of the illustrative integrated multibus master-slave system of FIG. 5 showing a configuration where additional arbitration capabilities within the customizable logic area are unused.

### DETAILED DESCRIPTION OF THE INVENTION

Persons of ordinary skill in the art will realize that the following description of the present invention is illustrative only and not in any way limiting. Other embodiments of the invention will readily suggest themselves to such skilled persons.

According to one aspect of the invention, more flexibility is provided for system bus arbitration when several masters are sharing slave modules in microcontroller systems employing a customizable logic area.

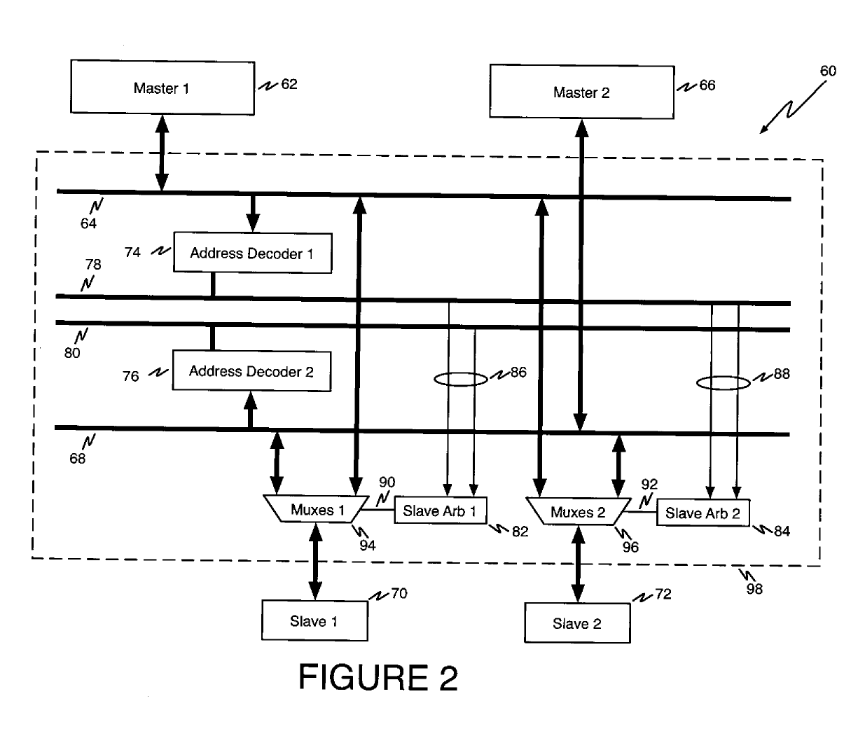

In a multi-bus system, data may be transferred between several masters and several slaves. Referring now to FIG. 2, such an exemplary system 60 is shown in which master-1 62 drives system bus-1 64 and master-2 66 drives system bus-2 68. As an example, master-1 62 may be a microprocessor and master-2 66 may be a direct memory access (DMA) controller. Of course, persons of ordinary skill in the art will appreciate that such architectures are not limited to the number and types of masters shown in FIG. 2. In case another master is required, another system bus is created.

In the exemplary system shown in FIG. 2, each master 62 and 66 can access slaves 70 and 72. To perform any access, the master sets signals on its respective system bus (address, data, control). Address decoders 74 and 76 are therefore designed to decode the address and control signals (not shown) carried on system buses 64 and 68. Each system bus 64 and 68 is coupled, respectively, to its address decoder 74 and 76. The address decoders 74 and 76 provide peripheral select signals, one designated for each slave and carried on busses 78 and 80.

Each of slaves 70 and 72 can be accessed by both masters 62 and 66. It is therefore necessary to provide a circuit to arbitrate access requests when two masters simultaneously request access to the same slave. According to the select signals on busses 78 and 80 that the slave arbiters 82 and 84 received on address decode lines 86 and 88, the slave arbiters 82 and 84 provide command signals on lines 90 and 92, respectively. These commands enable selection of system bus 1 (master-1 62) or system bus 2 (master-2 66) by means of multiplexers 94 and 96. The address decoders 74 and 76, slave arbiters 82 and 84, and multiplexers 94 and 96 together form a bus matrix 98.

Each slave arbiter 82 and 84 can have a different arbitration algorithm to effectively assign more or less bandwidth for each of masters 62 and 66. This algorithm is hard-coded in the circuitry of each slave arbiter as is known in the art.

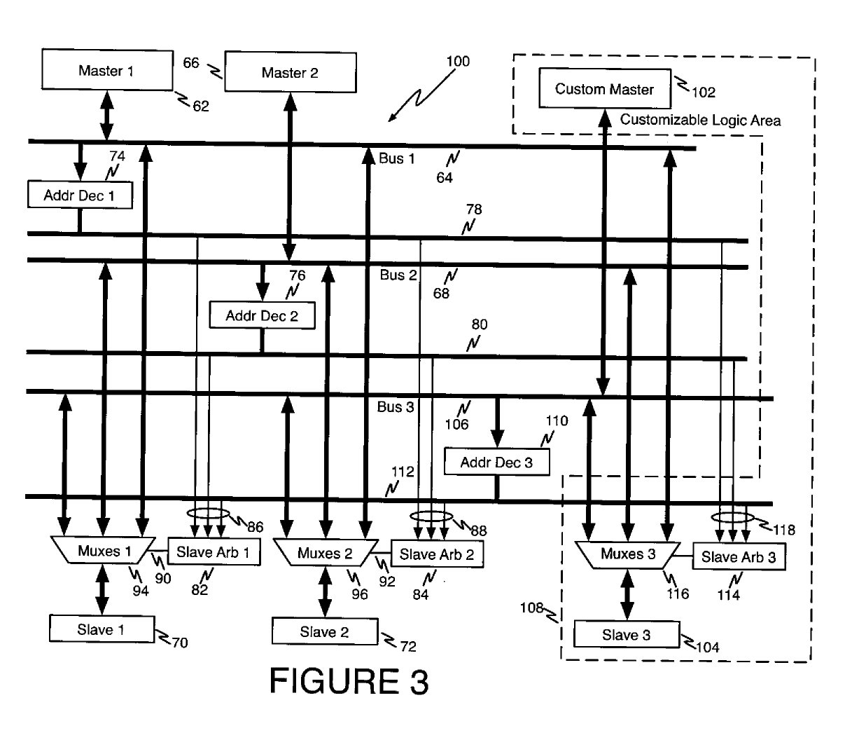

To provide more flexibility, a customizable area can be included in the circuitry of multi-system bus architectures. Accordingly, the predefined logic shown in FIG. 2 including the bus matrix 98 must be enhanced to handle this capacity increase. Referring now to FIG. 3, a block diagram shows such a prior-art multibus master-slave system 100 including a customizable logic area with a configured custom master module and a configured custom slave module. Elements in FIG. 3 performing the same function as corresponding elements in FIG. 2 will be designated by the same reference numerals used for the corresponding elements in FIG. 2.

In the example of FIG. 3, the customizable logic has been programmed to embed one additional master 102 and one additional slave 104. Therefore, an additional internal system bus 106 will have to be provided and the customizable area 108 is connected to the multi-system bus architecture. A third address decoder 110 and decoded address line 112 will also need to be provided. In addition, if a third slave 104 is added as is shown in FIG. 3, a third slave arbiter 114 and third multiplexer 116 will both be needed as shown in FIG. 3. The bus matrix ports will be increased by one master port and one slave port. These ports will be the I/O interface with the customizable logic.

As shown in FIG. 3, third address decoder 110, third slave arbiter 114, and third multiplexers 116 are shown formed in the configurable logic area 108. Persons of ordinary skill in the art will appreciate that some or all of these elements may be alternately disposed in the predefined circuit area with a corresponding increase in die size for the predefined circuit area.

In the example shown in FIG. 3, the arbitration algorithm is defined once and therefore the bandwidth allowed for one master-to-slave transfer cannot be tuned or adapted to the final application. As an example, assume a final application including a microcontroller that mainly handles the USB transfer of a domestic appliance. Even if the main function of the microcontroller is to perform USB transfers, it can from time to time be used to handle other specific functions including transfers with high bandwidth protocols such as ETHERNET. If ETHERNET protocol is not used to transfer a large amount of data, the bandwidth it requires may be lower than the bandwidth allocated to the USB function to avoid any interference in the USB transfer. If the arbitration is pre-defined it may be difficult to meet the constraints of a large and diverse group of final applications.

To provide more flexibility in the microcontroller architecture, some user arbitration capabilities must be introduced into the customizable logic area 108 and links to those capabilities must be designed and included in the predefined logic area. Multiplexers may be introduced between the predefined slave arbiters and the bus multiplexers whose outputs are driving the slave modules. The select inputs of these additional multiplexers may be driven by configuration registers that are part of a predefined logic slave (not necessarily the slave whose arbitration must be modified) and are accessible by a predefined master (microprocessor). Alternately, the configuration registers may be formed in the customizable logic area 108.

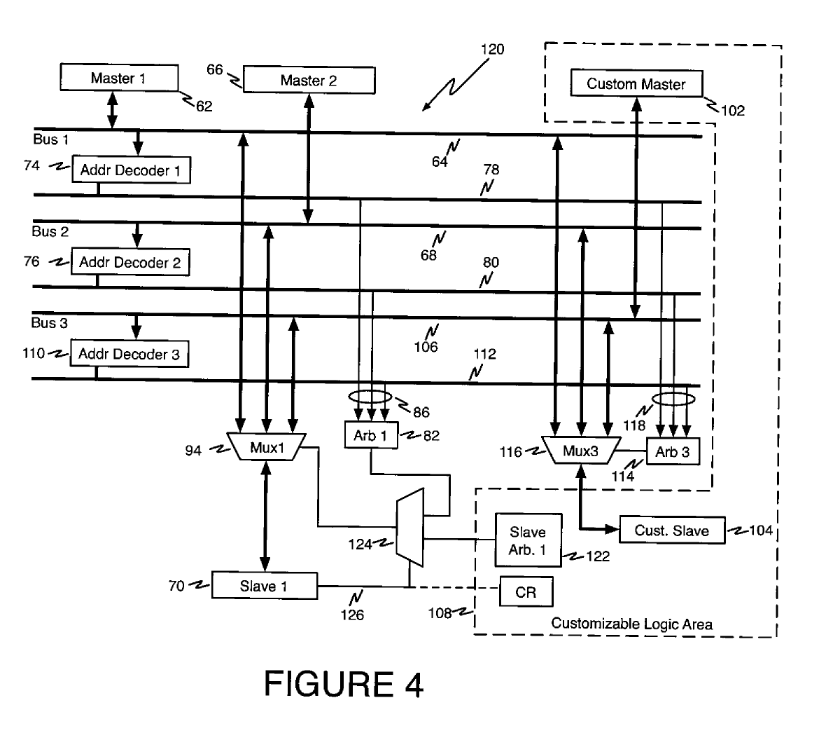

Referring now to FIG. 4, a block diagram shows an illustrative integrated multibus master-slave system 120 according to the present invention including a customizable logic area 108 with a configured custom master module 102 and a configured custom slave module 104 that includes additional arbitration capabilities disposed in the customizable logic area 108 with multiplexers 124 disposed in the predefined circuit area. Elements in FIG. 4 performing the same function as corresponding elements in FIGS. 2 and 3 will be designated by the same reference numerals used for the corresponding elements in FIGS. 2 and 3. For simplicity, the second multiplexers, arbiter, and slave are not shown in FIG. 4.

The third address decoder 110 is added for the third address bus 106 that will be driven by the custom master 102 and is shown located in the predefined circuit area. The third (custom) slave 104, third slave arbiter 114 driven by decoded address lines 118, and third multiplexers 116 are also located in the predefined circuit area.

According to this aspect of the invention, additional arbitration capabilities are provided and are formed in the customizable area 108. A custom user slave arbiter 122 for the first bus is formed in the customizable logic region 108. The output of user slave arbiter 122 is provided to an input of multiplexer 124. The other input of multiplexer 124 is driven by the output of slave arbiter 82. The select input of multiplexer 124 is controlled by the output 126 of a configuration register that may be located in the predefined logic area.

As shown in FIG. 4, the configuration register may be contained in a slave module 70 connected to a system bus and programmable/accessible through a master module. This configuration allows the user to choose between use of the predefined arbitration algorithm embodied in slave arbiter 82 and the user custom arbiter 122 formed in the customizable logic area 108. For users that do not need an arbitration algorithm other than the algorithm embedded in the predefined logic, the output terminal 126 of the customizable logic that drives the select input of multiplexer 124 can be programmed during the boot sequence of the system to a value corresponding to the predefined logic algorithm or left in its reset state if the reset state selects the predefined logic area arbiter.

The configuration register that drives the select input of multiplexer 124 may also be located in the customizable logic area 108. In this case, the number of terminals at the interface between the customizable logic area 108 and the predefined logic area will increase. If the configuration register that drives the select input of multiplexer 124 is located in the predefined logic area, it will be mandatory to write into the configuration register the value that activates the selection of inputs driven by customizable logic in case the user wants to use the customizable logic area arbiter.

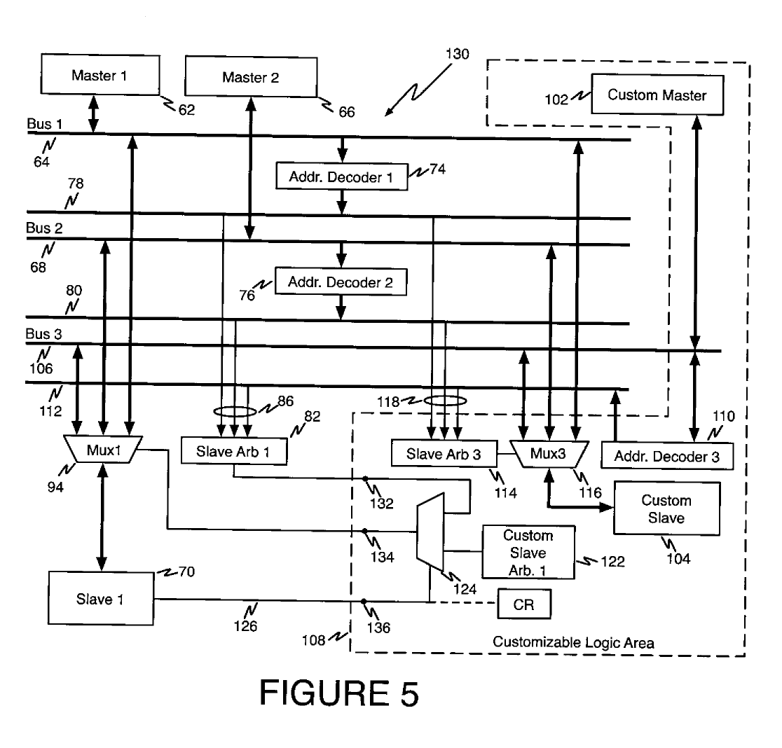

Referring now to FIG. 5, a block diagram shows an illustrative integrated multibus master-slave system 130 according to the present invention including a customizable logic area 108 with a configured custom master module 102 and a configured custom slave module 104 including additional arbitration capabilities with multiplexers formed in the customizable logic area 108. Elements in FIG. 5 that perform the same function as corresponding elements in FIGS. 2 through 4 will be designated by the same reference numerals used for the corresponding elements in FIGS. 2 through 4.

In FIG. 5, multiplexer 124 is shown formed in the customizable logic area 108. One of its inputs is coupled to the output of the user custom slave arbiter circuit 122 for bus 1 also formed in the customizable logic area 108 and the other input is coupled to the output of the slave arbiter-1 circuit 82 formed in the predefined logic area. Terminals 132, 134, and 136 from the I/O system of the customizable logic area 108 are used to make the connections between multiplexer 124, slave arbiter-1 circuit 82, multiplexers 94 and slave-1 module 70.

As in the circuit of FIG. 4, additional arbitration capabilities are provided and are formed in the customizable area 108. This configuration allows the user to choose between use of the predefined arbitration algorithm embodied in slave arbiter 82 and the user custom arbiter formed in the customizable logic area 108.

The configuration register that drives the select input of multiplexer 124 may also be alternatively located in the customizable logic area 108. In this case, the number of terminals at the interface between the customizable logic area 108 and the predefined logic area will increase. As in the circuit of FIG. 4, if the configuration register that drives the select input of multiplexer 124 is located in the predefined logic area, it will be mandatory to write into the configuration register the value that activates the selection of inputs driven by customizable logic.

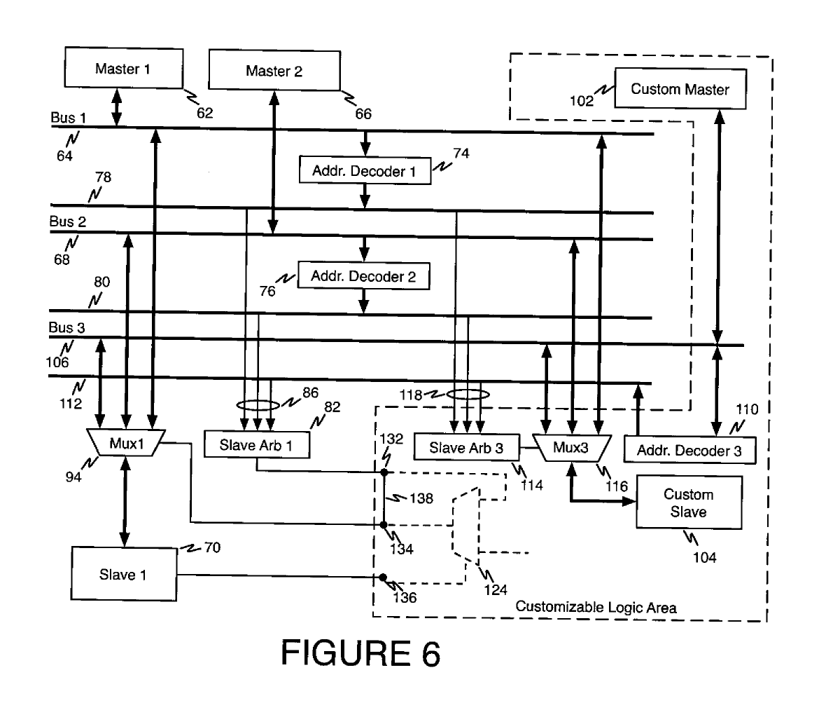

Referring now to FIG. 6, a block diagram of the illustrative integrated multibus master-slave system of FIG. 5 shows a configuration where additional arbitration capabilities within the customizable logic area 108 are unused. If, as shown in FIG. 6, the user does not want to implement its own slave arbitration algorithm for the existing bus system in the predefined logic area, then the terminals 132 and 134 of the customizable logic area 108 must be connected together in order to create a direct wire from output of slave arbiter 82 to the select input of multiplexer 94. This is shown diagrammatically in FIG. 6 as a wire 138 connecting terminals 132 and 134 together. Multiplexer 124, which in this case is not used and is thus not configured as a circuit in the customizable logic area 108, is shown for reference in dashed lines in FIG. 6.

The present invention provides several advantages over the current solutions. The architecture of the present invention is flexible. In some cases, such as system bus arbitration, it is difficult to make a new function possible simply by redundancy (i.e., duplicate the function and link it to the existing bus system). According to the present invention, the links exist, making it easy to substitute an alternate function.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A multibus system disposed on an integrated circuit and including:
a first master bus;
a first master device coupled to the first master bus;
a second master bus;
a second master device coupled to the second master bus;
a first multiplexer;
a first slave device coupled to the first and second master busses through the first multiplexer;
a first address decoder coupled to the first master bus and having a first decoded output associated with the first slave device;
a second address decoder coupled to the second master bus and having a first decoded output associated with the first slave device;
a first arbiter circuit multiplexer having a first input, a second input, a control input, and an output coupled to a select input of the first multiplexer;
a first arbiter circuit having inputs coupled to the first decoded outputs of the first and second address decoders, the first arbiter circuit having an output having an output state that is a predetermined function of the first decoded outputs of the first and second address decoders operated on by a fixed arbitration algorithm, the output of the first arbiter circuit coupled to the first input of the first arbiter circuit multiplexer; and
a configurable logic area disposed on the integrated circuit and having a first net coupled to the second input of the first arbiter circuit multiplexer.

2. The multibus system of claim 1 wherein the select input of the arbiter circuit multiplexer is coupled to a second net from the configurable logic area.

3. The multibus system of claim 1 wherein the select input of the arbiter circuit multiplexer is coupled to an output of a configuration register disposed on the integrated circuit.

4. The multibus system of claim 1 further including:
a third master bus; and
a third address decoder coupled to the third master bus and having a first decoded output associated with the first slave device and coupled to an input of the first arbiter circuit.

5. The multibus system of claim 1 further including:
a second multiplexer;
a second slave device coupled to the first and second master busses through the second multiplexer; and
a second arbiter circuit having inputs coupled to the first decoded outputs of the first and second address decoders, the second arbiter circuit having an output having an output state that is a predetermined function of the first decoded outputs of the first and second address decoders operated on by a fixed arbitration algorithm, the output of the first arbiter circuit coupled to a select input of the second multiplexer.

6. The multibus system of claim 5 wherein the select input of the arbiter circuit multiplexer is coupled to a second net from the configurable logic area.

7. The multibus system of claim 5 wherein the select input of the arbiter circuit multiplexer is coupled to an output of a configuration register disposed on the integrated circuit.

8. The multibus system of claim 5 further including:
a third master bus; and
a third address decoder coupled to the third master bus and having a first decoded output associated with the first and second slave devices and coupled to inputs of the first and second arbiter circuits.

9. A multibus system disposed on an integrated circuit and including:
a first master bus;
a first master device coupled to the first master bus;
a second master bus;
a second master device coupled to the second master bus;
a first multiplexer;
a first slave device coupled to the first and second master busses through the first multiplexer;
a first address decoder coupled to the first master bus and having a first decoded output associated with the first slave device;
a second address decoder coupled to the second master bus and having a first decoded output associated with the first slave device;
a first arbiter circuit multiplexer having a first input, a second input, a control input, and an output coupled to a select input of the first multiplexer;
a first arbiter circuit having inputs coupled to the first decoded outputs of the first and second address decoders, the first arbiter circuit having an output having an output state that is a predetermined function of the first decoded outputs of the first and second address decoders operated on by a fixed arbitration algorithm, the output of the first arbiter circuit coupled to the first input of the first arbiter circuit multiplexer; and
a configurable logic area disposed on the integrated circuit and having a first net coupled to the second input of the arbiter circuit multiplexer.

10. The multibus system of claim 9 wherein the select input of the arbiter circuit multiplexer is coupled to a second net from the configurable logic area.

11. The multibus system of claim 9 wherein the select input of the arbiter circuit multiplexer is coupled to an output of a configuration register disposed on the integrated circuit.

12. The multibus system of claim 9 further including:
a third master bus; and
a third address decoder coupled to the third master bus and having a first decoded output associated with the first slave device and coupled to an input of the first arbiter circuit.

13. The multibus system of claim 9 further including:
a second multiplexer;
a second slave device coupled to the first and second master busses through the second multiplexer; and
a second arbiter circuit having inputs coupled to the first decoded outputs of the first and second address decoders, the second arbiter circuit having an output having an output state that is a predetermined function of the first decoded outputs of the first and second address decoders operated on by a fixed arbitration algorithm, the output of the first arbiter circuit coupled to a select input of the second multiplexer.

14. The multibus system of claim 13 wherein the select input of the arbiter circuit multiplexer is coupled to a second net from the configurable logic area.

15. The multibus system of claim 13 wherein the select input of the arbiter circuit multiplexer is coupled to an output of a configuration register disposed on the integrated circuit.

16. The multibus system of claim 13 further including:
a third master bus; and
a third address decoder coupled to the third master bus and having a first decoded output associated with the first and second slave devices and coupled to inputs of the first and second arbiter circuits.
